(19) United States
(12) Patent Application Publication
(10) Pub. No.: US 2008/0081183 A1
(43) Pub. Date: Apr. 3, 2008

(54) MULTILAYER FILM

(76) Inventor: Jurjen DE BOER, Burgdorf (CH)

Correspondence Address: OSTROLENK FABER GERB & SOFFEN, 1180 AVENUE OF THE AMERICAS, NEW YORK, NY, 100368403, US

(21) Appl. No.: 11/538,153

(22) Filed: Oct. 3, 2006

(51) Int. Cl. B32B 27/32; B29C 55/28; B29C 47/06

(52) U.S. Cl. 428/339; 428/523; 428/516; 264/510; 264/564; 264/173.14

(57) ABSTRACT

An blow-extrudable film that ensures a reclosing ability after a first opening consists of a support layer on which a connecting layer and an overlying cover layer are arranged. The connecting layer essentially consists of a pressure sensitive hot melt adhesive. Both the support layer and the cover layer are essentially composed of polyethylene. The support layer may e.g. be made of low density and/or high density polyethylene (LD-PE respectively HD-PE). The cover layer consists of up to 100% LLD-PE (linear low density polyethylene) or of a blend of LLD-PE and polyethylene. Due to the LLD-PE content, the cover layer has a higher adhesion on the connecting layer than the support layer. In this manner it is ensured that in the first opening process, during which a portion of the support layer is separated, the connecting layer remains on the cover layer. Pressing the separated portion onto the connecting layer restores the bond between the separated portion and the film and recloses a container that is sealed by the film.

### FIELD OF THE INVENTION

The present invention relates to a blow-coextrudable multilayer film comprising a support layer and a cover layer that are connected by a connecting layer. The invention further relates to a method for producing a multilayer film and to its application.

### BACKGROUND OF THE INVENTION

An important application field of films is the packaging of foods. One known way of achieving this is to place the foods in a plastics container (tray) on which a film is placed and subsequently welded to the edges of the container. The disadvantage of such a package is that it can be opened only once. A reclosing ability would make it possible to remove only a part of the content and to store the remainder in the closed package at least for a short time.

### PRIOR ART

A reclosable film requires pressure-sensitive adhesives. Basically, such adhesives are known in the art. However, they often do not meet the requirements for packaging foods. Concepts for reclosable packages are also known in the art, e.g. from EP-A-0,868,368, EP-A-1,053,865, EP-A-0,661,154, and from GB-A-2,319,746. However, the concepts described therein do not allow to achieve a reclosing ability with films whose main constituents are based on polyethylene. In this regard, the term “main constituents” designates those layers which are relevant with respect to the weldability, the compatibility with foods, and the stability. Moreover, the suggested systems are generally unsuitable for producing films according to the blow coextrusion technique.

Fundamentally, another difficulty consists in embedding an adhesive layer, more particularly a hot melt adhesive layer, between two layers of a thermoplastic, in particular polyethylene, by the blow coextrusion technique. A suitable hot melt has recently been described in WO-A-02/064694, which is hereby incorporated into the specification by reference.

In the film indicated in this reference as an exemplary embodiment, the hot melt is embedded between two layers of a polymer blend by blow coextrusion. An essential component of both layers is an elastomeric metallocene C8 polyethylene (Engage 8480 [Dow Chemical]) having a relatively low DSC melting point of 100° C. and a low density of 0.902 g/cm³. Both characteristics indicate a high lateral chain density and a low crystallinity. In combination with the respective additional component (LD-PE respectively MD-PE [Medium Density PE]) in a proportion of only half respectively a third of the metallocene C8 PE, an elastic, soft material for the two layers results that has a relatively low DSC melting point near that of the hot melt. Both layers further contain approx. 5% of the usual additives such as slip agents and antiblocking agents.

All in all, this compound film is therefore unsuitable as a closure film for food packages due to its insufficient stability and excessive resilience. In fact, it is rather intended as a coating of a tray from a rigid polymer material that is sealed by a conventional closure film. When the package is opened, the sealing layer of the compound film is detached in the sealing zone, thereby causing a cohesive failure of the hot melt. Also, not least, the production of the tray is more complicated and thus more expensive due to the compound film on its surface and there is a risk for the hot melt to be exposed during the filling operation due to lesions of the surface and thus enters in direct contact with the foods.

### SUMMARY OF THE INVENTION

It is therefore an object of the present invention to provide such a (compound) film that is suitable for the packaging of foods, more particularly as a closure film of a tray, and offers a higher rigidity.

This is achieved by a multilayer film wherein
said connecting layer is essentially composed of a pressure sensitive hot melt adhesive,
said cover layer and said support layer are essentially composed of polyethylene, and
said cover layer contains an effective amount of a low density copolymer of ethylene and a longer-chained olefin having at least 3 carbon atoms, said copolymer being a LLD-PE and thus having an increased linearity as compared to low density polyethylene and a density of at least 0.910 g/cm³,
   in order to increase the adhesion between said hot melt adhesive and said cover layer to such an extent that said hot melt adhesive remains on said cover layer when the film is separated.

The dependent claims define preferred embodiments, production methods and applications of the film.

Accordingly, the film of the invention is essentially composed of a support layer and of a cover layer on the basis of polyethylene. More specifically, the cover layer distinguishes itself by an effective amount of a LLD-PE. Between the two layers there is a connecting layer that is essentially composed of a hot melt. The hot melt is essentially a hot-melt adhesive that also acts as a pressure-sensitive adhesive at room temperature, however. Particularly preferred is a hot melt substantially according to WO-A-02/064694 that has a melt index of at least 40.

Food packages are often composed of a lower portion, e.g. in the form of a tray, that is covered with a film and welded together with the film at its edges to form an airtight package. For the reclosability in the sense of the invention, it has been found to be essential that when the package is opened for the first time, the connecting layer remains as perfectly as possible on that part of the film that is peeled from the lower portion. Therefore, the connecting layer has to adhere to the cover layer better than to the support layer. Also, the adhesion on the support layer must be smaller than the cohesion of the connecting layer in order to avoid a so-called cohesive failure.

As a standard value for an easy opening of the film, an initial opening force of 5-6 N/cm or less and a propagation force of 2-5 N/cm can be assumed. The reopening force, i.e. the opening force required after reclosing, should be at least 1 N/cm also after repeated reclosing, e.g. 10 times.

It is known in the art to adjust these properties by additional adhesive agent layers between a connecting layer of this type and the adjacent polyethylene layers. However, these adhesive agent layers add complexity to the production process. According to EP-A-1,352,036, the adhesive agent may also be embedded in the hot melt. However, this results in an improved adhesion both on the cover and on the support layer in order to bring about a cohesive failure. Since hot melt also remains on the underside of the package when it is opened for the first time, this possibility is not applicable in the case of food packages.

It has now been found surprisingly that the adhesion of the hot melt on polyethylene materials can be controlled by using so-called LLD-PE or a blend of LLD-PE and LD-PE as the film material. LLD-PE is a copolymer of ethylene with longer-chained olefins, e.g. butene, hexene, or octene.

LLD-PE is produced by means of (heterogeneous) Ziegler-Natta catalysts. Heterogeneous Ziegler-Natta catalysts are preferred because of the stereo control of the polymerization and the accompanying crystallinity of the polymer. The thereby obtained stereotacticity yields a semicrystalline material. The stiffness of the material that is a result of the crystalline character is advantageous for the reclosability as it ensures that the portion that has been torn off will be repositioned on the tear-off zone.

Another class of PE materials whose density may range near that of LLD-PE is that of the metallocene PEs. These plastic materials are produced using metallocenes as catalysts. However, the catalyst molecules remain connected to the macromolecules growing thereon and produce no tacticity. In this manner, linked by the metallocene, macromolecule agglomerates having no crystallinity are formed. Due to the metallocene, metallocene PEs have a better adhesion, but due to the lower stiffness, a film of this material would be distorted and the tear-off zones would no longer coincide when reclosing them.

Metallocene PEs may have a density that is comparable to that of LLD-PE but their density is generally lower. For this reason and also because of the otherwise clearly different properties, even at a corresponding density, metallocene PEs are not designated as LLD-PE.

In this respect, for a higher stiffness, it is advantageous to use a LLD-PE having a density of at least 0.910 g/cm³, which denotes a correspondingly low number of lateral chains and a higher crystallinity but also a higher melting point and thus a high processing temperature.

In this manner, the adhesion of the hot melt on the cover layer of the multilayer film of the invention can be adjusted such that the hot melt layer is detachable from the support layer as a whole. Also, it is not necessary to use additional adhesive agents which make the production process more expensive. In particular, it is possible to produce such a film on a 3-layer coextrusion machine according to the blow coextrusion process.

### BRIEF DESCRIPTION OF THE DRAWINGS

The invention shall be further explained by means of an exemplary embodiment and with reference to figures. The indicated percentages will be understood as weight percentages in the entire description and in the claims unless otherwise specified.

FIG. 1 Cross-section through a compound film of the invention;

FIG. 2 Detail in the edge area of a container sealed with the film of the invention; and

FIG. 3 Detail according to FIG. 2 with the film peeled off.

### DETAILED DESCRIPTION OF PREFERRED EMBODIMENTS

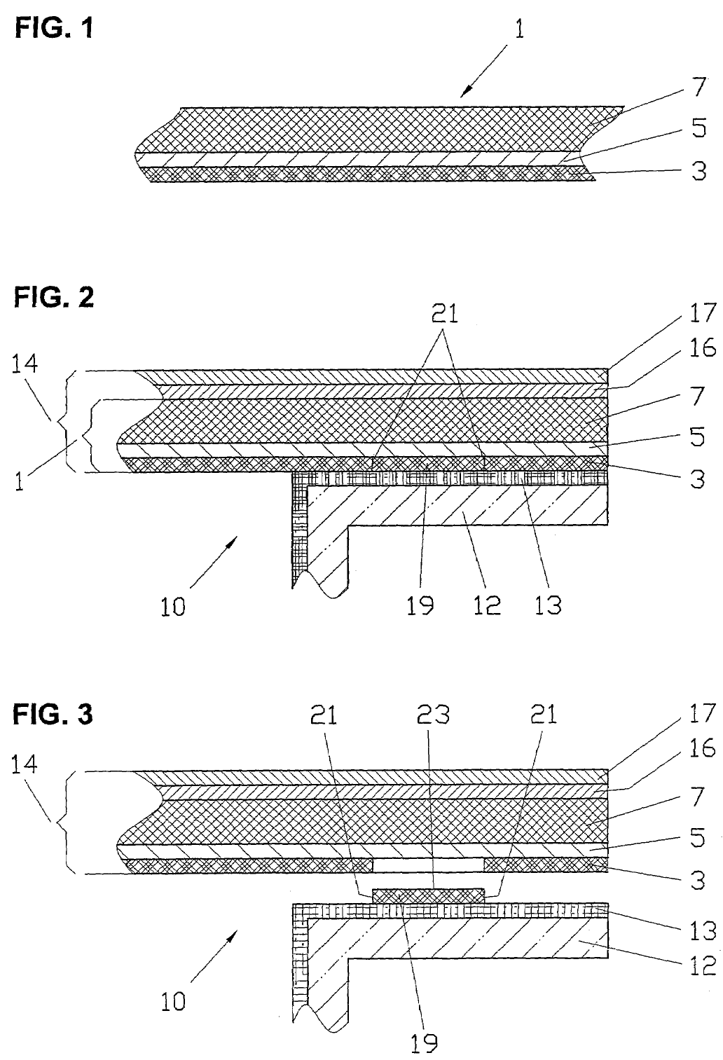

FIG. 1 shows the minimum configuration of a film 1 of the invention. It is essentially composed of the sealing and peel layer, hereinafter called support layer 3, of connecting layer 5, and of the laminating layer, hereinafter called cover layer 7.

Support layer 3 is made of low density polyethylene (LD-PE) as it is usual for packaging foils in the food sector. However, high density polyethylene (HD-PE) or a blend of HD-PE and LD-PE are also conceivable. It has turned out that the density of the support layer has to be at least 0.916 g/cm³, preferably at least 0.918 g/cm³ to ensure a clean tearing open of the package (see below). A possible explanation is that a higher proportion of LD-PE or a LD-PE having an insufficient density is too elastic and also has a better adhesion on the connecting layer. For the thickness of the support layer, a range of 0.005 to 0.040 mm has proven appropriate, in particular a thickness of approximately 0.015 mm. A support layer that is too thick also makes a clean tearing open of the package difficult, whereas a support layer that is too thin is not stable enough, e.g. while the film is welded to the container that is to be sealed by the film, or has an insufficient resistance when the container is torn open for the first time.

A further improvement in this respect can be achieved by a support layer that is produced without a so-called slip agent. However, if a slip agent is necessary, the reduction of the adhesion of the hot melt that is generally the result can be counteracted by a LLD-PE component in the support layer. This component is at most equal to that of the other polymers (LD-PE, HD-PE) and preferably substantially smaller, i.e. at most 30%.

Connecting layer 5 is a pressure sensitive hot melt adhesive that is known per se, i.e. a hot melt that readheres to a surface under pressure. In view of the blow extrusion process, a hot melt is selected whose set temperature is somewhat lower than that of polyethylene. For example, the set or processing temperature of the hot melt is of the order of 110° C.-160° C. if temperatures of around 185° C. for the cover layer (see below) and around 160° C. for the support layer are given. In the tests it has been found that hot melts having a melt index of up to 70 can be used. A hot melt having a melt index of 40 has proven particularly appropriate. The thickness of the connecting layer is comprised between 0.005 mm and 0.025 mm, preferably between 0.010 mm and 0.020 mm. The small thickness of as little as 0.01 mm or even 0.005 mm is possible due to the fact, amongst others, that the hot melt is completely detached from the sealing layer when the package is torn open since the adhesive reclosing force also increases with the thickness of the hot melt layer.

The hot melt essentially corresponds to WO-A-02/064694, however with a melt index of at least 40. Thus, the hot melt is composed as follows:
Styrene-based block copolymer, or a blend thereof. The polymer is essentially composed of styrene and of at least another monomer such as ethylene, propylene, isoprene, butadiene, or butene. Regarding the structures, di-, tri-, and multiblock types in linear, radial, or star-shaped configurations are encountered.
A compatible adhesive resin having a marked aliphatic character in order to improve the compatibility with the aliphatic component of the block copolymer. Suggested are e.g.: Polyterpenes, rosin, polymers from aliphatic or aromatic fractions, also hydrogenated.

The cover layer is composed of a low density or higher density polyethylene, possibly also of a blend thereof, with a proportion of a so-called linear low density polyethylene (LLD-PE). The LLD-PE component in cover layer 7 causes a better adhesion of the hot melt of connecting layer 5. Hence, when support layer 3 and cover layer 7 are pulled apart, connecting layer 5 will wholly remain on cover layer 7. An auxiliary condition therefor is that the adhesion of connecting layer 5 on support layer 3 is lower than the cohesion force within connecting layer 5, which is largely the case with the materials in question. In particular, the adhesion of hot melts to high and low density polyethylenes is correspondingly low. Specifically, in the cover layer, the use of LD-PE is preferred as this is the usual material for such films. On principle, it is also possible to use LLD-PE without a HD-PE and LD-PE content. However, experience shows that a suitable LLD-PE entails a lower output, thereby increasing the production costs. LLD-PE is a copolymerisate of polyethylene and of monounsaturated olefins having 4 to 8 C atoms (butene, hexene [branched and linear], octene). As a variant, a copolymerisate of ethylene and propylene is also conceivable. However, LLD-PE products including octene have proven particularly suitable.

The LLD-PE has a density of at least 0.910 g/cm³, preferably not more than 0.930 g/cm³, whereby the type and number of lateral chains is globally determined.

The content of LLD-PE may range from pure LLD-PE (100%) down to 20%. However, a preferred amount is 20% to 95% LLD-PE. Particularly good results have been obtained in the range of 40% to 85% LLD-PE.

For the blow coextrusion process, further additives that are known per se may be included in the layers, e.g. to improve the winding properties, such as antiblock agents, slip agents. However, the support layer contains no slip agent, or a certain amount of LLD-PE is contained in addition to the slip agent to compensate for the reduction of the adhesion of the hot melt on the support layer due to the slip agent.

A usual content of additives in a material is up to 5% of the total mass. The layers are thus essentially composed of the polymer material, i.e. besides the polymer material and the additives, they possibly contain only small amounts of other admixtures.

Generally, the thickness of the cover layer is at least equal to that of the support layer. In practice, when these conditions are fulfilled, the thickness is often comprised between 0.030 mm and 0.100 mm. On principle, however, there is no upper limit in this respect.

An exemplary film is composed of the following components:
Support layer:
   95-100% LD-PE, density: 0.927 g/cm³; type: Lupolen 3020K (Basell);
   0-5% additives.
Connecting layer:
   Hot melt adhesive M 3156/40 (Bostik Findley).
Cover layer:
   55-60% LD-PE: Lupolen 2424H (Basell);
   40% LLD-PE: Dowlex 5056 (Dow Chemical);
   0-5% additives.

FIG. 2 shows the edge area of a container 10 for foods, the preferred application of the film of the invention. Container 10 consists of a tray 12 coated with a sealing layer 13. The sealing layer is made of a material that is weldable to support layer 3 for connecting application film 14 to tray 12 in a gastight manner. Application film 14 is composed of film 1 as described above and of additional layers on top of the cover layer, namely a layer of a laminating adhesive 16 that connects barrier film 17 to film 1.

The film is welded on around the entire periphery in area 19 of support layer 3. When the package is opened for the first time, support layer 3 is torn apart at boundaries 21, as illustrated in FIG. 3. This first opening force, the so-called peel force, is therefore mainly determined by the thickness of support layer 3. Since the adhesion force between connecting layer 5 and cover layer 7 is significantly greater due to the LLD-PE content of cover layer 7 than the adhesion between connecting layer 5 and support layer 3, area 19 is neatly detached from connecting layer 5. Thus, substantially no adhesive residues remain on the surface of area 19 and there is a smaller risk that foreign matter deposits and adheres thereon, thereby affecting the reclosability. Due to the pressure sensitivity of the hot melt adhesive of connecting layer 5, the package can be reclosed in a simple manner by pressing film 14 back onto tray 12 and thus surface 23 onto the surface of cover layer 5 so that the latter adhere to each other.

Since film 1 is composed of only 3 layers, it can be advantageously produced on a conventional coextrusion installation by three-layer extrusion. The extrusion installation has to be equipped for processing LD-PE and LLD-PE if LD-PE is used for the support layer and possibly also in the cover layer. The processing temperatures of the applied polyethylene types are adjusted as usual in the art. The hot melt adhesive is processed at a set temperature that is somewhat lower than that of the polyethylene. The additional layers (laminating adhesive, barrier film) are applied by a conventional technique after the extrusion of the film to thus obtain the application film.

From the preceding description, modifications and developments are accessible to those skilled in the art without leaving the protective scope of the invention as defined by the claims. Conceivable are in particular:
The application of additional and/or different layers on top of the cover layer, e.g. in order to adjust the permeability to substances and radiation (light), to improve the printability, etc.
Using the film of the invention instead of the tray: To this end, a film without a barrier is used whose upper side (cover layer) is weldable to the support layer. Arrangements of two or a plurality of films are possible that are welded together in pairs at least peripherally and where two or a plurality of objects (e.g. cheese slabs) are enclosed between two respective films. Due to the reclosability, the objects may then be withdrawn individually and the package reclosed around the remaining ones. The barrier film would impair the weldability, but such a film is possible on the outer films.

### GLOSSARY

DSC Differential scanning calorimetry

HD-PE High density polyethylene

LD-PE Low density polyethylene

LLD-PE Linear low density polyethylene

MD-PE Medium density polyethylene

Melt index Melt index, DIN 53735 (1983)

1. A blow-coextrudable multilayer film comprising a support layer and a cover layer that are connected by a connecting layer, wherein
said connecting layer is essentially composed of a pressure sensitive hot melt adhesive,
said cover layer and said support layer essentially consist of polyethylene, and
said cover layer contains an effective amount of a low density copolymer of ethylene and a longer-chained olefin having at least 3 carbon atoms, said copolymer being a LLD-PE and thus having an increased linearity as compared to low density polyethylene and a density of at least 0.910 g/cm³,
in order to increase the adhesion between said hot melt adhesive and said cover layer to such an extent that said hot melt adhesive remains on said cover layer when the film is separated.

2. The multilayer film of claim 1, wherein the cohesion force of said hot melt adhesive is greater than its adhesion force with respect to the material of said support layer so that said support layer is separable from said hot melt adhesive essentially without hot melt adhesive residues.

3. The multilayer film of claim 1, wherein said longer-chained olefin has 3 to 8 C atoms, preferably 4-8 and more preferably 8 C atoms and is monounsaturated in the monomer state.

4. The multilayer film of claim 1, wherein said copolymer has a density of 0.910 g/cm³ to 0.930 g/cm³.

5. The multilayer film of claim 1, wherein the copolymer content in said upper layer is from 20 to 100 weight %, preferably 20 to 95 weight %, and more preferably 40 to 85 weight %.

6. The multilayer film of claim 1, wherein the thickness of said connecting layer is 0.005 mm to 0.025 mm, preferably 0.01 mm to 0.02 mm.

7. The multilayer film of claim 1, wherein the melt index of said hot melt adhesive is in the range of 40 to 70 and preferably amounts to about 40.

8. The multilayer film of claim 1, wherein said support layer is essentially a HD-PE, a LD-PE, a blend of HD-PE and LD-PE, or a blend of the aforementioned materials with a LLD-PE, the LLD-PE content in this blend being at most 50%, preferably at most 30%.

9. The multilayer film of claim 1, wherein the density of said support layer is at least 0.916 g/cm³, preferably at least 0.918 g/cm³.

10. The multilayer film of claim 9, wherein said support layer is essentially composed of LLD-PE or of a blend of LLD-PE with HD-PE, with LD-PE or with a blend of HD-PE and LD-PE.

11. The multilayer film of claim 1, wherein said support layer is 0.005 to 0.04 mm thick.

12. The multilayer film of claim 1, wherein said support layer is essentially free of a slip agent or includes an effective amount of a slip agent and an amount of LLD-PE in order to compensate for a reduction of the adhesion between said support layer and said hot melt caused by the slip agent.

13. The multilayer film of claim 1, wherein said cover layer is at least as thick as said support layer.

14. A method for producing the multilayer film of claim 1, wherein at least the portion that is composed of said support layer, said connecting layer, and said cover layer is produced by the blow coextrusion technique.

15. The method of claim 14, wherein said hot melt adhesive is processed at a set temperature that is at most equal to that of the material of said support layer and preferably no more than 50° C. lower than the latter.

16. The application of the film of claim 1 as a closure film on a container, a tray, and/or a film of a food package, the closure film being welded to the edge of said container, tray, or film, respectively.
